(19) United States
(12) Patent Application Publication
(10) Pub. No.: US 2016/0016569 A1
(43) Pub. Date: Jan. 21, 2016

(54) BOOSTER, RESISTANCE FORCE APPLYING APPARATUS, AND STROKE SIMULATOR

(71) Applicant: HITACHI AUTOMOTIVE SYSTEMS, LTD., Ibaraki (JP)

(72) Inventors: Atsushi ODAIRA, Yokohama-shi (JP); Takuya USUI, Yokohama-shi (JP)

(21) Appl. No.: 14/797,657

(22) Filed: Jul. 13, 2015

(30) Foreign Application Priority Data
Jul. 16, 2014 (JP) 145881/2014

(51) Int. Cl. B60T 8/40; B60T 7/04

(52) U.S. Cl. CPC B60T 8/4077; B60T 7/042; B60T 8/4086

(57) ABSTRACT

The present invention controls an electric motor according to a stroke that an input rod performs in response to an operation performed on a brake pedal, and thrusts a primary piston, thereby generating a brake hydraulic pressure in a master cylinder. The brake hydraulic pressure is fed back to the input rod via an input piston and an input plunger. The present invention applies a sliding resistance against the stroke of the input rod by pressing a frictional member of a resistance force applying mechanism against a tapering sliding portion of the input rod with the aid of a spring force of a spring member. A taper angle of the sliding portion allows the sliding resistance to change at a varying ratio according to a position of the input rod, which can lead to stable application of a desired sliding resistance.

### TECHNICAL FIELD

The present invention relates to a booster, a resistance force applying apparatus, and a stroke simulator mounted in a brake apparatus of a vehicle such as an automobile.

### BACKGROUND ART

For example, Japanese Patent Application Public Disclosure No. 2013-10470 discloses a technique for improving a feeling that an operator has when operating a brake pedal, by applying a reaction force and a friction force against a stroke of the brake pedal with use of an elastic frictional member such as a rubber in such a manner that a difference is made in the reaction force (a hysteresis) between when the operator presses the brake pedal and when the operator releases the brake pedal.

### SUMMARY OF INVENTION

However, the above-described technique disclosed in Japanese Patent Application Public Disclosure No. 2013-10470 involves such a problem that the reaction force and the friction force are acquired with the aid of the elastic frictional member such as the robber, and therefore become inconstant as the rubber and the like are subject to a temperature change and a change over time, which makes it difficult to achieve a stable operational characteristic.

An object of the present invention is to provide a booster, a resistance force applying apparatus, and a stroke simulator that allow the operator to operate the brake pedal with the stable operational characteristic.

According to an aspect of the present invention, a booster includes a housing, an input member disposed movably in a housing and coupled to a brake pedal, an electric motor configured to be actuated in response to an operation performed on the brake pedal, an assist mechanism configured to thrust a piston in a master cylinder by the actuation of the electric motor, and a resistance force applying mechanism configured to apply a resistance force against a displacement of the input member relative to the housing. The resistance force applying mechanism includes a sliding portion having an inclination formed at the input member, and a sliding member configured to apply a sliding resistance against the displacement of the input member by slidably contacting the sliding portion. The resistance force applying mechanism is configured in such a manner that the sliding resistance changes at a varying ratio according to a position of the input member relative to the housing.

According to another aspect of the present invention, a stroke simulator, which configured to apply a reaction force against a displacement of an input member coupled to a brake pedal, includes a sliding member configured to apply a sliding resistance against the displacement of the input member, and a sliding portion provided at a member in which the input member is inserted and configured to slidably contact the sliding member. At least one of the input member and the sliding portion is provided with an inclination extending along a direction in which the input member is displaced, thereby causing the sliding resistance to change at a varying ratio according to a position of the input member.

According to still another aspect of the present invention, a resistance force applying apparatus, which is configured to apply a resistance force against a stroke of a rotatably supported brake pedal, includes a rotational member coupled to a rotational shaft of the brake pedal, and a sliding member configured to apply a sliding resistance against a rotation of the rotational member by slidably contacting the rotational member. At least one of the sliding member, and a sliding portion of the rotational member, which the sliding member slidably contacts, has an inclination to cause the sliding resistance to change at a varying ratio according to a rotational position of the rotational member.

### Advantageous Effects of Invention

According to the present invention, the operator can operate the brake pedal with the stable operational characteristic.

### BRIEF DESCRIPTION OF DRAWINGS

FIG. 1 is a vertical cross-sectional view illustrating an electric booster according to a first embodiment of the present invention.

FIG. 2 is a transverse cross-sectional view illustrating a resistance force applying unit or the electric booster illustrated in FIG. 1.

FIGS. 3A to 3C illustrate how a resistance force applying mechanism operates in the electric booster illustrated in FIG. 1.

FIGS. 4A to 4C are graphs each indicating a relationship between a stroke and a pressing force in the electric booster illustrated in FIG. 1.

FIG. 5 is a vertical cross-sectional view illustrating a main part of a modification of the electric booster illustrated in FIG. 1.

FIG. 6 is a partially cutaway view illustrating a resistance force applying unit of the electric booster illustrated in FIG. 5.

FIG. 7 is a vertical cross-sectional view illustrating an outline of a configuration of a stroke simulator according to a second embodiment of the present invention.

FIGS. 8A to 8C are graphs each indicating a relationship between a stroke and a pressing force in the stroke simulator illustrated in FIG. 7.

FIG. 9 is a perspective view illustrating an outline of a configuration of a brake pedal on which a resistance force applying apparatus according to a third embodiment of the present invention is mounted.

FIGS. 10A and 10B are vertical cross-sectional views illustrating an outline of a configuration of the resistance force applying apparatus illustrated in FIG. 9.

### DESCRIPTION OF EMBODIMENTS

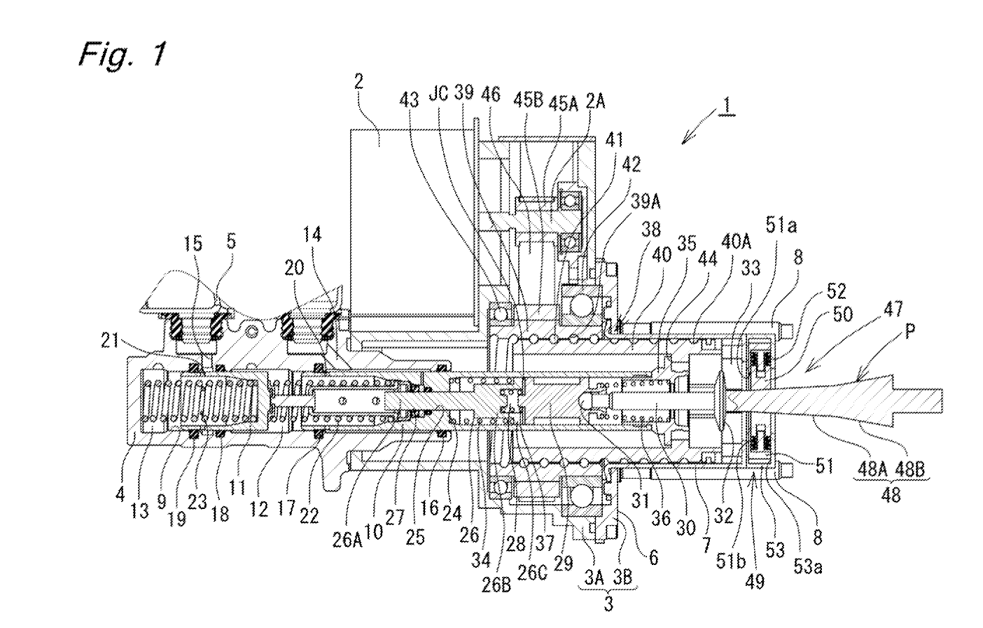

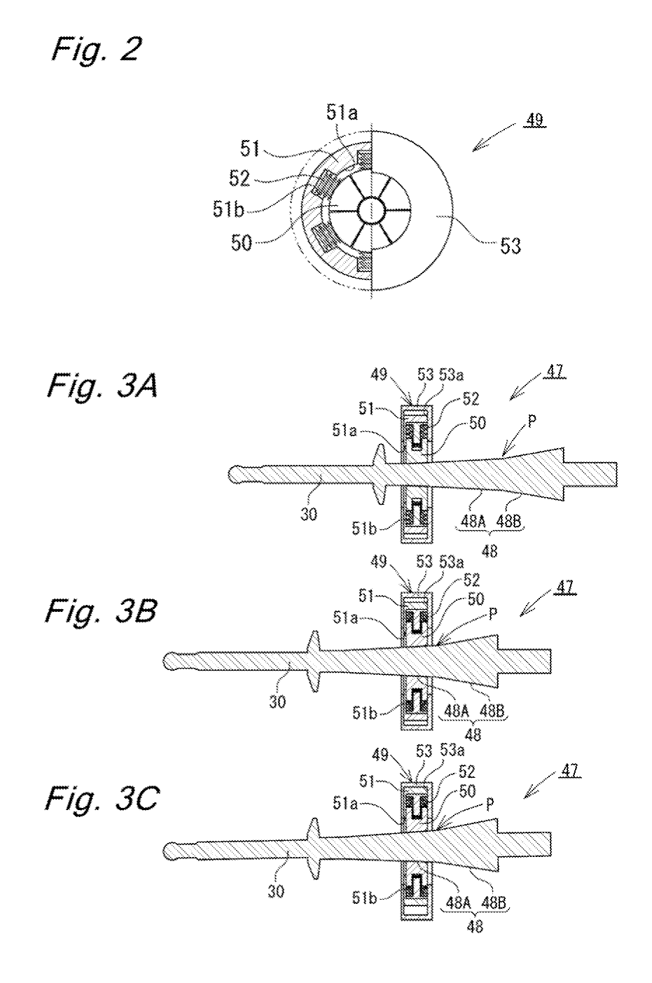

In the following description, embodiments of the present invention will be described in detail with reference to the drawings. An electric booster according to a first embodiment of the present invention will be described with reference to FIGS. 1 to 4.

As illustrated in FIG. 1, the electric booster 1 according to the present embodiment is a booster that operates with use of an electric motor 2, which is an electric actuator, as a driving source thereof. The electric booster 1 has a structure including a housing 3 and a tandem-type master cylinder 4 coupled to one axial side (a front side, a left side in FIG. 1) of the housing 3. A reservoir 5 (only a part thereof illustrated), which supplies brake fluid to the master cylinder 4, is mounted on a top of the master cylinder 4. The housing 3 is formed by coupling a rear cover 3B to an opposite end side of a generally cylindrical stepped front housing 3A.

A fiat mounting seat surface 6 is formed at the rear cover 3B of the housing 3. A cylindrical portion 7 is provided at the rear cover 3E so as to protrude coaxially with the master cylinder 4 from a center of this mounting seat surface 6 toward an opposite axial side (a rear side, a right side in FIG. 1) of the housing 3, i.e., in a direction away from the master cylinder 4. The electric booster 1 is disposed in an engine room and is fixed to a dash board by a plurality of stud bolts 8 fixed to the mounting seat surface 6 in such a state that the cylindrical portion 7 penetrates through the dash board (not illustrated), which serves as a partitioning wall between the engine room and a passenger compartment of the vehicle, to extend into the passenger compartment.

A bottomed cylinder bore 9 is formed in the master cylinder 4. A generally cylindrical primary piston 10 (a piston) is disposed on an opening side of this cylinder bore 9. A front end side (the left side in FIG. 1) of this primary piston 10 has a cup-like shape, and is disposed in the cylinder bore 9. Further, a cup-shaped secondary piston 11 is disposed on a bottom, side of the cylinder bore 9. A rear end of the primary piston 10 extends from the opening of one master cylinder 4 into the housing 3, and extends as far as into the cylindrical portion 7 of the rear cover 3B. A primary chamber 12 and a secondary chamber 13 are defined between the primary piston 10 and the secondary piston 11, and between the bottom of the cylinder bore 9 and the secondary piston 11, respectively, in the cylinder bore 9 of the master cylinder 4. These primary chamber 12 acid secondary chamber 13 are each connected to a wheel cylinder (not illustrated) of each of wheels from a hydraulic port (not illustrated) of the master cylinder 4 via two hydraulic circuit systems.

Further, reservoir ports 14 and 15 are provided at the master cylinder 4. The reservoir ports 14 and 15 allow the primary chamber 12 and the secondary chamber 13 to be connected to the reservoir 5, respectively. Annular piston seals 16, 17, 18, and 19 are mounted on an inner circumferential surface of the cylinder bore 9 with predetermined axial intervals maintained among them, to seal between the inner circumferential surface of the cylinder bore 9 and the primary and secondary pistons 10 and 11. The piston seals 16 and 17 are disposed axially opposite of the reservoir port 14, which is one of the reservoir ports, from each other. Then, when the primary piston 10′ is located at a not-braking position illustrated in FIG. 1, the primary chamber 12 is in communication with the reservoir port 14 via a piston port 20 formed through a sidewall of the primary piston 10. Then, as the primary piston 10 advances from the not-braking position so that the piston port 20 reaches the piston seal 17, which is one of the piston seals, the primary chamber 12 is disconnected from the reservoir port 14 by the piston seal 17, by which a hydraulic pressure is generated therein.

Similarly, the remaining two piston seals 18 and 19 are disposed axially opposite of the reservoir port 15 from each other. When the secondary piston 11 is located at the not-braking position illustrated in FIG. 1, the secondary chamber 13 is in communication with the reservoir port 15 via a piston port 21 formed through a sidewall of the secondary piston 11. Then, as the secondary piston 11 advances from the not-braking position, the secondary chamber 13 is disconnected from the reservoir port 15 by the piston seal 19, by which a hydraulic pressure is generated therein.

A spring 22 is disposed between the primary piston 10 and the secondary piston 11. Further, a spring 23 is disposed between the bottom of the cylinder bore 9 and the secondary piston 11.

The primary piston 10 has a generally cylindrical shape as a whole, and includes an intermediate wall 24 at an axial center therein. A guide bore 25 axially penetrates through the intermediate wall 24. a small-diameter portion 26A of a stepped input piston 26 is slidably and liquid-tightly inserted in the guide bore 25. The input piston 26 includes the small-diameter portion 26A on a front end side and a large-diameter portion 26B on a rear end side. A seal 27 seals between the small-diameter portion 26A of the input piston 26 and the guide bore 25. A spring bearing 26C shaped like an outer flange is formed at a rear portion of the large-diameter portion 26B of the input piston 26. An outer circumferential portion of the spring bearing 26C axially movably guides the input piston 26 by slidably abutting against an inner wall of the primary piston 10. Further, a spring bearing recess 28 is formed at a rear end of the input piston 26. The input piston 26 is configured in such a manner that a front end of the small-diameter portion 26A thereof faces the primary chamber 12 in the master cylinder 4, and the input piston 26 is axially movable relative to the primary piston 10.

An input plunger 29 is axially slidably guided behind the input piston 26 in a rear portion of the primary piston 10. A front end of an input rod 30 is coupled to a rear end of the input plunger 29 so as to allow the input rod 30 to tilt to some degree by a ball joint 31. The front end side of the input rod 30, which is coupled to the input plunger 29, is disposed in the cylindrical portion of the rear cover 3B and the rear portion of the primary piston 10, and a rear end side of the input rod 30 extends out of the cylindrical portion 7. A brake pedal (not illustrated) is coupled to the rear end of the outwardly extending input rod 30, and the input rod 30 is axially displaced by art operation performed on the brake pedal. In other words, in the present embodiment, the input rod 30 corresponds to an input member and a rod-shaped member. A flange-shaped stopper abutment portion 32 is formed at an intermediate portion of the input rod 30 disposed in the cylindrical portion 7. A radially inwardly extending stopper 33 is formed at a rear end of the cylindrical portion 7. Then, a position to which the input rod 30 can be displaced rearward is regulated by abutment of the stopper abutment portion 32 against the stopper 33.

A first spring 34, which is a compression coil spring, is disposed between the intermediate wall 24 of the primary piston 10 and the spring bearing 26C formed at the rear end of the input piston 26. Further, a second spring 36, which is a compression coil spring, is disposed between the rear end of the input plunger 29 and a spring bearing 35 mounted at the rear end of the primary piston 10. A jump-in spring 37, which is a compression coil spring, is inserted in the spring bearing recess 26C at the rear end of the input piston 26. This jump-in spring 37 is disposed between the input piston 26 and the input plunger 29.

The input piston 26 and the input plunger 29 are elastically maintained at a neutral position illustrated in FIG. 1, i.e., a position where spring forces of the first spring 34 and the second spring 36 are balanced, with the aid of the first spring 34 and the second spring 36. The input piston 26 and the input plunger 29 are configured movably forward and rearward from this neutral position relative to the primary piston 10. In a not-braking state illustrated in FIG. 1, the first spring 34 and the jump-in spring 37 are provided with similar set loads, and a jump-in clearance JC (a gap) is formed, between the input piston 26 and the input plunger 23. Then, the input piston 26 and the input plunger 29 are configured relatively movably by a distance corresponding to this jump-in clearance JC.

A ball screw mechanism 38, which is a rotation-linear motion conversion mechanism, is contained in the housing 3. The ball screw mechanism 38 is an assist mechanism that is driven by the electric motor 2 disposed, in the housing 3, and converts a rotational motion into a linear motion to apply a thrust force to the primary piston 10. The ball screw mechanism 38 includes a nut member 39, which is a rotational member, and a screw shaft 40, which is a linearly moving member. The nut member 39 is rotatably supported by bearings 42 and 43 in the housing 3. The screw shaft 40 has a hollow cylindrical shape. The screw shaft 40 is disposed in the nut member 39 and the cylindrical portion 7 of the housing 3, and is supported by the housing 3 so as to be permitted to be displaced along the axial direction but prohibited from rotating around the axis. Spiral grooves 39A and 40A are formed on an inner circumferential surface of the nut member 39 and an outer circumferential surface of the screw shaft 40, respectively. Balls 41, which are a plurality of rolling members, are loaded between these spiral grooves 39A and 40A together with grease. The screw shaft 40 is supported so as to be permitted to be guided movably along the axial direction by the stopper 33 of the cylindrical portion 7 but prohibited from rotating around the axis. By this configuration, the balls 41 roll along the spiral grooves 39A and 40A as the nut member 39 rotates, which causes the screw shaft 40 to be axially displaced. The ball screw mechanism 38 is configured to be able to convert the rotational motion and the linear motion reciprocally between the nut member 39 and the screw shaft 40. The rear end of the primary piston 10 is inserted in the screw shaft 40, and the spring bearing 35 abuts against an annular stepped portion 44 formed at an inner circumferential portion of the screw shaft 40, which regulates a position to which the primary piston 10 can be displaced rearward relative to she screw shaft 40. This configuration allows the primary piston 10 to advance together with the screw shaft 40 by being pushed by the stepped portion 44 as the screw shaft 40 advances, and also advance alone by separating from the stepped portion 44.

The electric motor 2 is disposed in the housing 3 around a different axis from the axis around which the master cylinder 4, the input rod 30, and the ball screw mechanism 38 are disposed. A pulley 45A is attached to an output shaft 2A of the electric motor 2. A belt 46 is wound between this pulley 45A and a pulley 45B attached to the nut member 39 of the ball screw mechanism 33. The electric motor 2 is configured to actuate (rotate) the nut member 39 of the ball screw mechanism 38 via a belt transmission mechanism including the pulleys 45A and 45B and the belt 46 wound therebetween.

A resistance force applying mechanism 47, which applies a resistance force against the displacement of the input rod 30 relative to the housing 3, is provided at the rear end of the cylindrical portion of the rear cover 3B. The resistance force applying mechanism 4 includes an inclination formed behind the stopper abutment portion 32 of the input rod 30, i.e., a tapering sliding portion 48, and a resistance force applying unit 49 mounted at the rear end of the cylindrical portion 7 of the housing 3. The sliding portion 48 is shaped to taper toward the front side of the input rod 30, and includes a first taper portion 46A on a front side and a second taper portion 46B on a rear side. The first taper portion 48A tapers at a small taper angle (an inclination), and the second taper portion 48B capers at a large taper angle. In the present embodiment, the housing 3 of the electric booster 1 is also used as a housing of the resistance force applying unit 49, but the present embodiment may be configured in such a manner that the housing of the resistance force applying unit 49 is prepared as a separate body from the housing 3 of the electric booster 1, and this housing is disposed fixedly to the vehicle.

The resistance force applying unit 49 includes sliding members 50, a guide member 51, spring members 52, and a floating support member 53. The sliding members 50 are embodied by a plurality of generally fan-shaped members (six members in she illustrated example), and are disposed radially around the sliding portion of the input rod 30. The guide member 51 has an annular body including a penetrating groove 51a, which is an inner circumferential groove, at a center thereof, and guides each of the sliding members 50 radially movably and movably forward and rearward (in leftward and rightward directions in FIG. 1) relative to the sliding portion 48 of the input rod 30. Further, spring bearing grooves 51b are formed in the penetrating groove 51a of the guide member 51 so as to be radially disposed opposite from the sliding members 50. The spring members 52 are compression coil springs respectively mounted for the individual sliding members 50, and one end sides thereof are supported by the spring bearing grooves 51b of the guide member 51, and urge the individual sliding members 50 toward a center of the resistance force applying unit 49, i.e., the sliding portion 48 of the input member 30. The floating support member 53 has a radial groove 53a, which is an inner circumferential groove, and has an annular shape. The floating support member 53 supports the guide member 51 movably radially, i.e., in a direction perpendicular to the axial direction of the input rod 30.

Respective axial lengths of the first and second taper portions 48A and 48A of the input rod 30 are set in such a manner that a boundary P between the first taper portion 48A and the second taper portion 48B is located at a position opposite from the sliding members 50 of the resistance force applying unit 49 when an output of the electric motor 2 according to a stroke of the input rod 30 reaches a maximum value and the primary piston 10 stops (a full load state).

The electric booster 1 is provided with a rotational position sensor (not illustrated) that detects a rotational position of the electric motor 2, a stroke sensor (not illustrated) that detects the stroke of the input rod 30, and a controller (not illustrated) that controls actuation of the electric motor 2 based, on output signals from these sensors and is configured based on a microprocessor. If necessary, the controller can be connected to an in-vehicle controller and the like for performing various kinds of brake control such as regenerative brake control, brake assist control, and automatic brake control.

Next, an operation of the electric booster 1 will be described.

When an operator pushes the input rod 30 forward by operating the brake pedal, the controller controls the actuation of the electric motor 2 based on an amount of the operation, performed on the brake pedal, i.e., the strobe of the input rod 30. The electric motor 2 rotationally drives the nut member 39 of the bail screw mechanism 38 via the pulleys 45A and 45B and the belt 46, which causes the screw shaft 40 to advance and thus the stepped portion 44 to push the spring bearing 35 of the primary piston 10 to thereby thrust the primary piston 10 and displace the primary piston 10 according to the stroke of the input rod 30. As a result, the hydraulic pressure is generated in the primary chamber 12, and this hydraulic pressure is transmitted to the secondary chamber 13 via the secondary piston 11. In this manner, the brake hydraulic pressure generated in the master cylinder 4 is supplied into the wheel cylinder of each of the wheels, and generates a braking force for frictional braking.

When the operator releases the operation performed on the brake pedal, the controller reversely rotates the electric motor 2 based on the stroke of the input rod 30, which causes the primary piston 10 and the secondary piston 11 to be displaced rearward, reducing the hydraulic pressure in the master cylinder 4 to release the braking force. In the following description, only an operation of the primary piston. 10 side will be described, because the primary piston 10 and the secondary piston 11 operate in a similar manner.

When the hydraulic pressure is generated, the hydraulic pressure in the primary chamber 12 is received by the small-diameter portion 26A of the input piston 26, and a reaction force thereof is transmitted, i.e., fed back to the brake pedal via the input plunger 29 and the input rod 30. This configuration allows a desired braking force to be generated at a predetermined boosting ratio (a ratio of a hydraulic output to a force of operating the brake pedal). Then, the controller is configured to be able to control the actuation of the electric motor 2, and adjust a relative position between the input piston 26 and the primary piston 10 following the input piston 26. More specifically, the controller can increase the hydraulic output with respect to the operation performed on the brake pedal by adjusting a position of the primary piston 10 relative to a stroke position of the input piston 26 to the front side, i.e., the master cylinder 4 side, and reduce the hydraulic output with respect to the operation performed on the brake pedal by adjusting the position of the primary piston 10 relative to the stroke position of the input piston 26 to the rear side, i.e., the brake pedal side. As a result, the controller can perform the brake control such as the boosting control, the brake assist control, vehicle-to-vehicle distance control, and the regenerative brake control.

Next, a jump-in characteristic at the beginning of brake application will be described.

When the brake application starts, the jump-in clearance JC is maintained between the input piston 26 and the input plunger 29 by a spring force of the jump-in spring 37 as illustrated in FIG. 1. When the brake pedal is pressed to cause the input rod 30 to advance, and the controller actuates the electric motor 2 to cause the primary piston 10 to advance, thereby starting generation of the hydraulic pressure in the master cylinder 4, the reaction force from the hydraulic pressure that is applied from the primary chamber 12 to the input piston 26 is not transmitted to the input plunger 29 end the input rod 30 while the jump-in clearance JC is maintained. This can lead to acquisition of the jump-in characteristic that quickly raises the brake hydraulic pressure by reducing the reaction force to the brake pedal at the beginning of the brake application. After that, as the pressure in the primary chamber 12 increases, the input piston 26 is brought into abutment with the input plunger 29 with the aid of the reaction force thereof, thereby starting transmitting the reaction force to the input rod 30, i.e., the brake pedal.

At this time, a jump-in hydraulic pressure Pj is expressed by the following expression.

Pj=(k1+k3)JC/S

In this expression, valuables represent the following items.
k1: a spring constant of the first spring 34
k3: a spring constant of the jump-in spring 3
S: an area or the input piston 26 that receives the pressure from the primary chamber 12.
JC: the jump-in clearance

Further, even when the bail screw mechanism 38 becomes unable to operate due to, for example, a failure at the electric motor 2 or the controller, the input piston 26 advances by the operation performed on the brake pedal to cause the front end of the large-diameter portion 26B of the input piston 26 to press the intermediate wall 24 of she primary piston 10, which can generate the hydraulic pressure in the master cylinder 4, thereby succeeding in maintaining the braking function.

Next, an operation of the resistance force applying mechanism 4 will be described.

In the electric booster 1, the resistance force (a sliding resistance) is applied against the stroke that the input rod 30 performs in response to the operation performed on the brake pedal, by the sliding members 50 of the resistance applying unit 49 that are pressed against the sliding portion 48 of the input rod 30 with the aid of the spring forces of the spring members 52. This resistance force changes according to pressing farces of the sliding members 50, i.e., the spring forces of the spring members 52, and increases as the input rod 30 continues the stroke due to the inclination of the sliding portion 48.

At this time, in the electric booster 1, when the output of the electric motor 2 controlled by the controller reaches the maximum value with a balance established between the hydraulic pressure in the primary chamber 12 and the thrust force of the primary piston 10, the primary piston 10 stops moving by being prohibited from advancing more than that. When the operator further presses the brake pedal in this full load state, this results in a forward displacement of the input piston 26 alone with the primary piston 10 remaining stationary as the input rod 30 advances. At this time, since the primary piston 10 remains stationary, the reaction force, which is transmitted to the brake pedal due to the increase in the hydraulic pressure in the primary chamber 12, increases at a lower ratio to the advance amount of the input piston 26 compared to this ratio before the full load state. Therefore, the operator may feel uncomfortable due to the reduction in the pedal reaction force in the middle of the braking operation.

Then, the electric booster 1 according to the present embodiment is configured in such a manner that, when the stroke of the input rod 30 reaches the position corresponding to the above-described full load state, the position at which the sliding members press the sliding portion 48 is switched from the first taper portion 48A tapering at the small taper angle to the second taper portion 48B tapering at the large taper portion 48B, which causes the resistance force to change at a different ratio to the stroke of the input rod 30, i.e., the resistance force to start increasing at a higher ratio. As a result, the reduction in the pedal reaction force due to the full load state can be canceled out by the increase in the resistance force, which can reduce the uncomfortable feeling caused by the reduction in the pedal reaction force. Therefore, the operator can operate the brake pedal with a stable operational characteristic.

As illustrated in FIG. 3C, the input rod 30 may tilt as it performs the stroke in response to the operation performed on the brake pedal, but the sliding members of the resistance force applying unit are radially disposed over an entire circumference of the input member, thereby succeeding in following the tilt of the input rod 30 to some degree. Further, the guide member 51, which guides the sliding members 50, is supported by the floating support member 53 movably perpendicularly to the axial direction of the input rod 30, thereby succeeding in allowing the sliding members 50 to follow the tilt of the input rod 30 to thereby apply the stable resistance force.

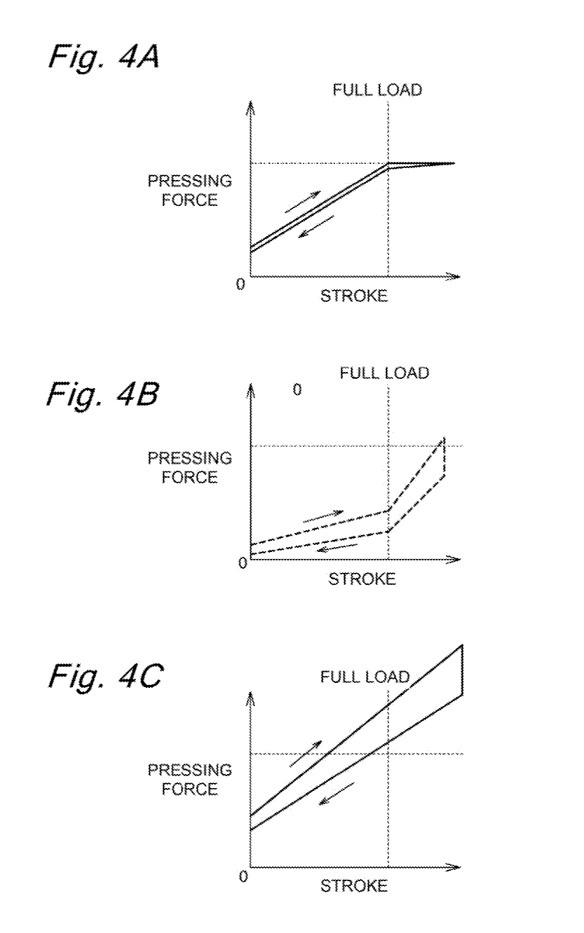

FIGS. 4A, 4B, and 4C illustrate relationships between the stroke and the pressing force (the operation force) of the brake pedal (the input rod) in the electric booster 1. FIG. 4A illustrates the relationship when the resistance force applying mechanism 47 is not used. FIG. 4B illustrates the relationship when the resistance force is applied to the input rod by the resistance force mechanism. FIG. 4C illustrates the relationship when the resistance force applying mechanism 47 is used (a combination of FIGS. 4A and 4B). As illustrated in FIG. 4C, applying the resistance force with use ox the resistance force applying mechanism 47 can compensate for the reduction in the reaction force in the full load state, thereby succeeding in improving the feeling than the operator has when operating the brake pedal. Further, applying the sliding resistance with use of one resistance force applying mechanism 47 causes the force of pressing the pedal with respect to the stroke of the brake pedal to exhibit such a hysteresis characteristic that this force is weaker at the time of a brake release than at the time of the brake application, thereby succeeding in acquiring the excellent operation feeling. This allows the operator to operate the brake pedal with the stable operational characteristic.

The sliding portion 48 of the input rod 30 can be not only shaped like the above-described first and second taper portions 48A and 48B, but also shaped in such a manner that the sliding resistance changes at a varying ratio to she stroke of the input rod 30 so that the required sliding resistance can be acquired. In a case where the sliding resistance is unnecessary, the sliding portion 48 may have a portion out of contact with the sliding members 50. Then, for example, the sliding portion 48 can be configured in such a manner than the inclination thereof allows the sliding resistance to increase until the input rod 30 reaches a predetermined position, and increase at a lower ratio after the input rod 30 reaches the predetermined position, as the input rod 30 is displaced in response to the pressing of the brake pedal. In this case, for example, when the electric booster 1 performs the control in cooperation with a not-illustrated regenerative brake mechanism of the vehicle, the predetermined position is set to an end of a pedal stroke region where only regenerating braking is applied and the hydraulic reaction force of the electric booster 1 is not transmitted to the pedal (for example, a stroke region corresponding to a deceleration of approximately 0.3 G or less). This arrangement results in an increase in the sliding resistance according to the stroke in the stroke region of the regenerative braking, and allows the operator to acquire the desired feeling about the braking operation even when the sliding resistance starts increasing at the lower ratio due to transmission of the hydraulic reaction force of the electric booster 1 to the brake pedal after the input rod 30 reaches the predetermined position.

Further, the sliding portion 48 can be configured in such a manner that the inclination thereof allows the sliding resistance to be maintained constant until the input rod 30 reaches a predetermined position, and increase after the input rod 30 reaches the predetermined position, as the input rod 30 is displaced in response to the pressing of the brake pedal. This arrangement can reduce the uncomfortable feeling caused by the reduction in the pedal reaction force, for example, when the output of the electric motor 2 reaches the maximum and the input piston 26 advances relative to the primary piston 10.

Further, the spring members 52 can be each embodied by a linear spring or a non-linear spring having a spring constant varying according to a radial position of the sliding member 50, according to a desired characteristic. Further, the sliding portion 48 may be configured to be inclined in a constant manner, and but have a varying frictional coefficient of a surface of the sliding portion according to the axial position so that the sliding resistance changes at the varying ratio.

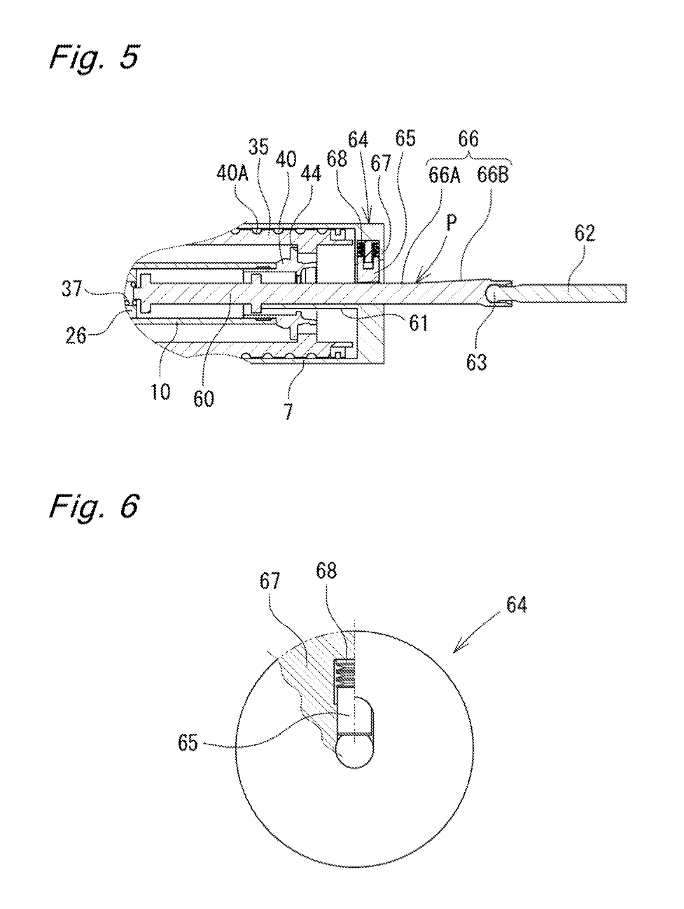

Next, a modification of the above-described first embodiment will be described with reference to FIGS. 5 and 6. The present modification is configured similarly to the above-described first embodiment except for including a different input plunger, a different input rod, and a different resistance force applying mechanism. Therefore, in the following description, like features will be identified by like reference numerals, and only different features will be described in detail.

As illustrated in FIGS. 5 and 6, in the present modification, a rear portion of an input plunger 60 extends out of the cylindrical portion of the housing 3. More specifically, the input plunger 60 is supported so as to be axially movably guided and be prohibited from tilting by a plunger guide 61 fixed to the cylindrical portion 7. An input rod 62 coupled to the brake pedal is connected to a rear end of the input plunger 60 extending out of the cylindrical portion 7 by a bail joint 63.

A sliding portion 66, which slidably contacts a sliding member 65 of a resistance force applying unit 64, is provided at the input plunger 60. The sliding portion 66 is a sliding surface formed by chamfering one side of a cylinder guided by the plunger guide 61. In the illustrated example, the sliding portion 66 includes a flat first sliding surface 66A on a front side of the sliding surface, and a second sliding surface 66B on a rear side of the sliding surface. The second sliding surface 66B is largely inclined at a rear portion thereof. A boundary between, the first sliding surface 66A and the second sliding surface 66B is located at a position opposite from the sliding member 65 of the resistance force applying unit 64 when, the output of the electric motor 2 reaches the maximum and the primary piston 10 stops (the full load state).

The single sliding member 65 is provided at the resistance force applying unit 64 at a position opposite from the sliding portion 66 of the input plunger 60. The sliding member 65 is guided by a guide member 67 movably toward and away from the sliding portion 66, and is urged toward the sliding portion 66 by a spring member 68. Further, the guide member 6 is fixed to the cylindrical portion of the housing 3.

By this configuration, the sliding member 65 of the resistance force applying unit 64 is pressed against the sliding portion 66 of the input plunger 60 with the aid of a spring force of the spring member 68, by which the resistance force (the sliding resistance) is applied against a stroke that the input rod 62 performs in response to the operation performed on the brake pedal. Then, before the stroke of the input rod 62 is placed into the above-described full load state, the sliding resistance is maintained constant due to the flat first sliding surface 66A. After the full load state is established, the sliding resistance increases according to the stroke due to the inclination of the second sliding surface 66B. In this manner, the sliding resistance changing at the varying ratio allows the operator to acquire the desired braking feeling from the sliding resistance of the sliding portion 66 in a similar manner to the above-described first embodiment. In the present modification, the input plunger 60 including the sliding portion 66 is prohibited from tilting, which eliminates the necessity of the floating support by the guide member 67 of the resistance force applying unit 64. Further, the present modification may be configured to adopt a varying spring constant of the spring member 68, or a varying frictional coefficient of a surface of the sliding portion 66 so that the sliding resistance changes at the varying ratio, in a similar manner to the above-described first embodiment.

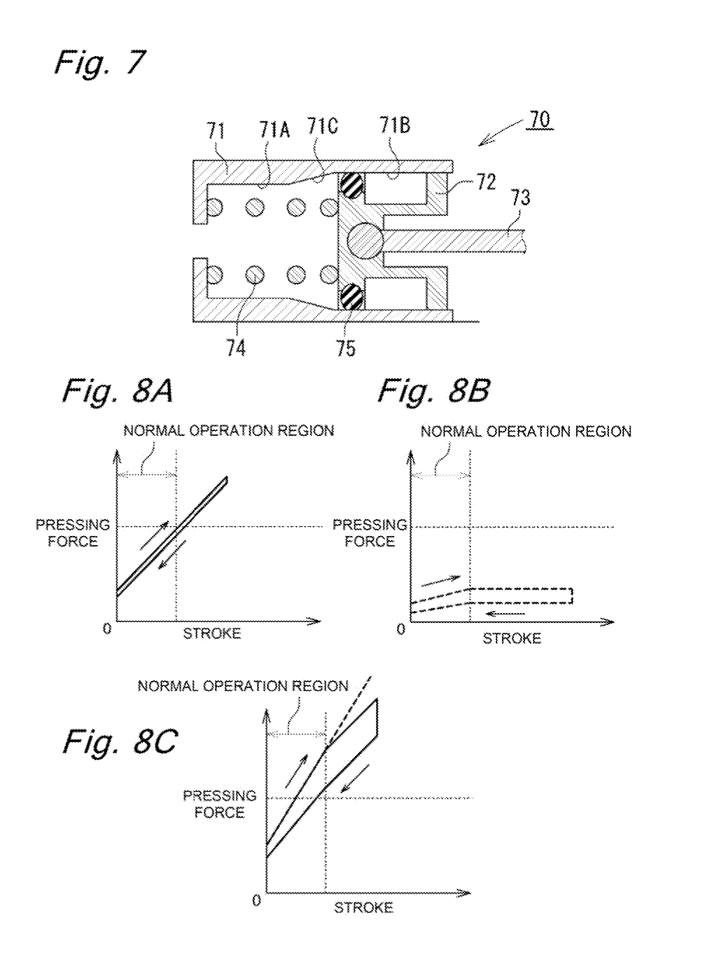

Next, a second embodiment of the present invention will be described with reference to FIGS. 7 and 8. The present embodiment is an embodiment in which the present invention is applied to a stroke simulator that exerts a reaction force to a brake pedal while being mounted in a so-called brake-by-wire system that generates a braking force in response to an electric signal based on a stroke of the brake pedal without the brake pedal and a frictional brake directly mechanically connected to each other via a hydraulic circuit and the like.

As illustrated in FIG. 7, a stroke simulator 70 according to the present embodiment includes a generally bottomed cylindrical housing 71, a slider 72 that is axially movably guided, in the housing 71, an input rod 73 connecting the slider 72 and a brake pedal (not illustrated) to each other and serving as an input member inserted in the housing 71, and a reaction force spring 74 that is a compression coil spring disposed between a bottom of the housing 71 and the slider 72. In the present embodiment, the housing 71 corresponds to a member in which the input member is inserted.

On an inner circumferential surface of the housing 71, a small-diameter cylindrical surface 71A is formed on the bottom side, and a guide surface 71B as a large-diameter cylindrical surface is formed on an opening side. Further, on the inner circumferential surface of the housing 71, a taper surface 71C as an inclined surface connecting the cylindrical surface 71A and the guide surface 71B is formed between the cylindrical surface 71A and the guide surface 71B. In the present embodiment, the inner circumferential surface of the housing 71 corresponds to a sliding portion. The slider 72 is guided along the guide surface 71B, and an elastic sliding member 75, which slidably contacts the taper surface 71C and the cylindrical surface 71A, is attached to a front end of the slider 72.

A brake system with the stroke simulator 70 mounted thereon includes a fail-safe mechanism that allows the frictional brake to be directly actuated in response to an operation performed on the brake pedal via the hydraulic circuit and the like in case of a failure in the brake-by-wire system.

Next, an operation of the thus-configured stroke simulator 70 will be described.

A reaction force is applied by the reaction force spring 74, and a sliding resistance is also applied by a sliding movement of the elastic sliding member 75 sliding on the taper surface 71C and the cylindrical surface 71A against a stroke of the brake pedal, i.e., the input rod 73. In a region in which the brake pedal operates normally (for example, the region corresponding to the deceleration of approximately 0.3 G or less), the elastic sliding member 75 slidably contacts the taper surface 71C, which allows an operator to acquire a desired feeling about a braking operation due to the sliding resistance increasing according to the stroke. In case that the brake-by-wire system breaks down, when the stroke of the brake pedal exceeds the above-described normal operation region to achieve a required braking force by the fail-safe mechanism, the elastic member 75 slidably contacts the cylindrical surface 71A, which can reduce an increase in the sliding resistance and thus reduce an increase in the brake pressing force.

FIGS. 8A to 8C illustrate relationships between the stroke and the pressing force (the operation force) of the brake pedal (the input rod) in the stroke simulator 70. FIG. 8A illustrates the relationship when the reaction force is applied by the reaction force spring 74. FIG. 8B illustrates the relationship when the sliding resistance is applied by the elastic sliding member 75. FIG. 8C illustrates the relationship when a reaction force is applied as a combination of the reaction force by the reaction force spring 74 and the sliding resistance by the elastic sliding member 75. As illustrated in FIG. 8C, the increase in the reaction force at the time of the large strobe exceeding the normal operation region can be reduced by making an adjustment in such a manner that the sliding resistance by the elastic sliding member 75 changes at the varying ratio with the aid of the taper surface 71C and the cylindrical surface 71A. Further, the force of pressing the pedal with respect to the stroke of the brake pedal exhibits such a hysteresis characteristic that this force is weaker at the time of the brake release than at the time of the brake application in a similar manner to the above-described first embodiment, which allows the operator to acquire the excellent operation feeling. Therefore, the operator can operate the brake pedal with the stable operational characteristic.

Then, the present embodiment can be configured in such a manner that the inclination of the sliding surface in the housing 71 allows the sliding resistance to increase until the input rod 73 reaches a predetermined position, and increase at a higher ratio after the input rod 73 reaches the predetermined position, as the input rod 73 is displaced in response to the pressing of the brake pedal. Further, the present embodiment can be configured in such a manner that the reaction force spring 74, which is a spring member, is embodied by a non-linear spring having a varying spring constant according to a position of the slider 72 with the elastic sliding member 75 provided thereon.

In the present embodiment, the taper surface 71C, which is the inclined surface, is formed on the inner circumferential surface of the housing 71, which corresponds to the sliding portion. However, the present embodiment may be a stroke simulator configured in such a manner that the inclination is provided at the input rod 73 and the sliding member is supported on the housing 71 side, in a similar manner to the above-described first embodiment. Further, the present embodiment may be configured to adopt a varying spring constant of the elastic spring member 75, or a varying fractional coefficient of the inner circumferential surface of the housing 71 so that the sliding resistance changes at the varying ratio, in a similar manner to the above-described first embodiment.

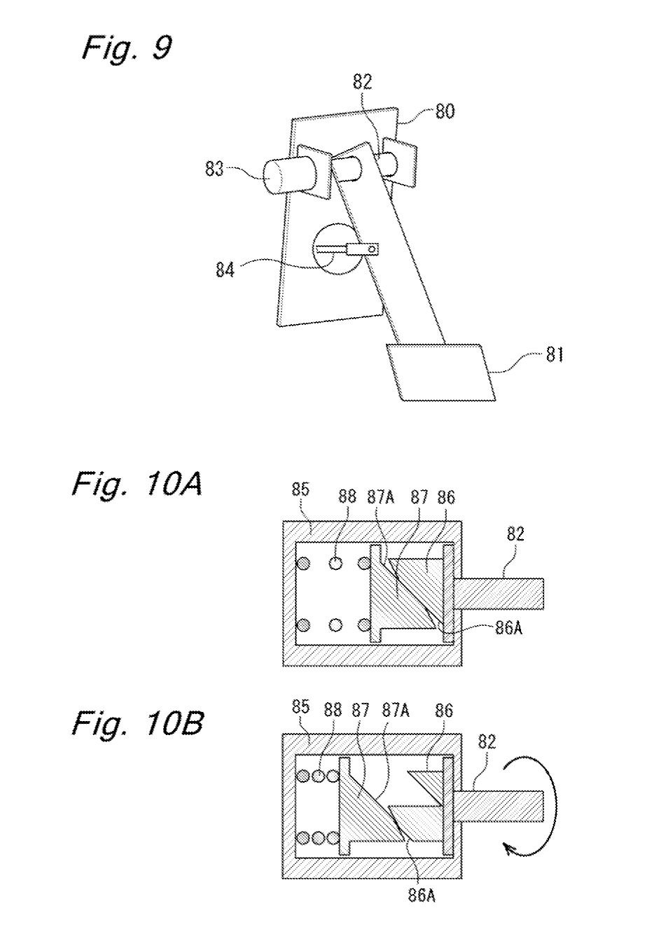

Next, a third embodiment of the present embodiment will be described with reference to FIGS. 9 and 10. The present embodiment is a resistance force applying mechanism that is mounted at a shaft supporting a brake pedal, and applies a resistance force against a stroke of the brake pedal.

As illustrated in FIG. 9, a resistance force applying mechanism 83 is mounted at a rotational shaft 82 of a brake pedal 81 rotatably supported by a brake bracket 80. An input rod 84, which transmits a force of operating the brake pedal 81 to a brake system (not illustrated), is coupled to the brake pedal 81.

As illustrated in FIG. 10A, the resistance force applying mechanism includes a generally bottomed cylindrical housing 85 fixed to the brake pedal bracket 80, a rotational cam member 86 that is a rotational member disposed in the housing 85, a linearly moving cam member 87 that is a sliding member opposite from the rotational cam member 86, and a spring member 88 that is a compression coil spring disposed between the linearly moving cam member 87 and a bottom of the housing 85. The rotational cam member 86 is coupled to the rotational shaft 82 of the brake pedal 81, and rotates as the brake pedal 81 performs a stroke. The rotational cam member 86 and the linearly moving cam member 87 include inclined cam surfaces 86A, and 87A engageable with each other, respectively, and are configured in such a manner that the linearly moving cam member 87 is displaced toward the bottom side of the housing 85 against a spring force of the spring member 88 according to a rotation of the rotational cam member 86. The cam surfaces 86A and 87A of the rotational cam member 86 and the linearly moving cam member 87 are in sliding contact with each other with an appropriate friction generated therebetween.

By this configuration, as the brake pedal 81 performs the stroke, the rotational cam member 86 rotates and the linearly moving cam member 87 is displaced against the spring force of the spring member 88 due to the engagement between the cam surfaces 86A and 87A, by which a resistance force (a reaction force) is applied. At this time, a sliding resistance (a friction force) between the cam surfaces 86A and 87A is applied as a resistance force, by which the above-described hysteresis characteristic can be acquired. Then, the resistance force can be set to a desired characteristic by inclinations, shapes (cam profiles), and a frictional coefficient of the cam surfaces 86A and 87A, and a spring constant of the spring member 88 (a linear spring member, or a non-linear spring member having a spring coefficient varying according no a position of the linearly moving cam member 87).

In the present embodiment, both the cam surfaces 86A and 87A have the inclinations, but any one of them may have the inclination. Then, this inclination allows the sliding resistance to increase until the rotational cam member 86 reaches a predetermined rotational position, and change at a different ratio, i.e., change at a higher ratio after the rotational cam member 86 reaches the predetermined rotational position, as the rotational cam member 86 rotates in response to pressing of the brake pedal 81. The present embodiment may be configured to realize the change in the sliding resistance by having a varying spring constant of the spring member 88, or a varying frictional coefficient of the cam surfaces 86A and 87A, in a similar manner to the above-described first embodiment.

The electric booster 1 according to the above-described embodiment includes the housing, the input member disposed movably in the housing and coupled to the brake pedal, the electric motor configured to be actuated according to the operation performed on the brake pedal, the assist mechanism configured to thrust the piston of the master cylinder by the actuation of the electric motor, and the resistance force applying mechanism configured to apply the resistance force against the displacement of the input member relative to the housing. The resistance force applying mechanism includes the sliding portion having the inclination formed on the input member, and the sliding member configured to apply the sliding resistance against the displacement of the input member by slidably contacting the sliding portion. The resistance force applying mechanism is configured in such a manner that the sliding resistance changes at the varying ratio according to the position of the input member relative to the housing.

According to the thus-configured configuration, it is possible to improve the feeling that the operator has when operating the brake pedal. Further, it is possible to allow the operator to operate the brake pedal with the stable operational characteristic.

In the electric booster 1 according to the above-described embodiment the sliding portion is configured in such a manner that the inclination allows the sliding resistance to increase until the input member reaches the predetermined position, and increase at the higher ratio after the input member reaches the predetermined position, as the input member is displaced in response to the pressing of the brake pedal.

According to this configuration, it is possible to reduce the uncomfortable feeling caused by the reduction in the pedal reaction force even when the output of the electric motor 2 reaches the maximum and the input piston 26 advances relative to the primary piston 10, while securing the hysteresis characteristic.

In the electric booster 1 according to the above-described embodiment, the sliding portion is configured in such a manner that the inclination allows the sliding resistance to increase until the input member reaches the predetermined position, and increase at the lower ratio after the input member reaches the predetermined position, as the input member is displaced in response to the pressing of the brake pedal.

According this configuration, even when the electric booster 1 performs the control in cooperation with the regenerative brake mechanism of the vehicle, the operator can acquire the desired feeling about the braking operation.

In the electric booster according to the above-described embodiment, the sliding portion is configured in such a manner that the inclination allows the sliding resistance to be maintained constant until the input member reaches the predetermined position, and increase after the input member reaches the predetermined position, as the input member is displaced in response to pressing of the brake pedal.

According to this configuration, it is possible to reduce the uncomfortable feeling caused by the reduction in the pedal reaction force even when the output of the electric motor 2 reaches the maximum and the input piston 26 advances relative to the primary piston 10.

In the electric booster according to the above-described embodiment, the resistance force applying mechanism includes the spring member configured to urge the sliding member toward the sliding portion of the input member, and the spring member has the spring coefficient varying according to the position of the sliding member being displaced toward and away from the sliding portion along the inclination.

According to this configuration, it is possible to reduce the uncomfortable feeling caused by the redaction in the pedal reaction force even when the output of the electric motor 2 reaches the maximum and the input piston 26 advances relative to the primary piston 10.

The stroke simulator according to the above-described embodiment, which is configured to apply the reaction force against the displacement of the input member coupled to the brake pedal, includes the sliding member configured to apply the sliding resistance against the displacement of she input member, and the sliding portion provided at the member in which the input member is inserted and configured to slidably contact the sliding member. At least one of the input member and the sliding portion is provided with the inclination extending along the direction in which the input member is displaced, thereby causing the sliding resistance to change at the varying ratio according to the position of the input member.

According to the thus-configured configuration, it is possible to improve the feeling that the operator has when operating the brake pedal. Further, it is possible to allow the operator to operate the brake pedal with the stable operational characteristic.

In the stroke simulator according to the above-described embodiment, the sliding portion is configured in such a manner that the inclination allows the sliding resistance to increase until the input member reaches the predetermined position, and increase at the higher ratio after the input member reaches the predetermined position, as the input member is displaced in response to the pressing of the brake pedal.

According to this configuration, it is possible to reduce the increase in the sliding resistance and thus reduce the increase in the braking pressing force even when the brake-by-wire system breaks down, while securing the hysteresis characteristic.

The stroke simulator according to the above-described embodiment includes the spring member configured to apply the spring force against the displacement of the input member, and the spring member has the spring constant varying according to the position of the sliding member.

According to the thus-configured configuration, it is possible to improve the feeling that the operator has when operating the brake pedal. Further, it is possible to allow the operator to operate the brake pedal with the stable operational characteristic.

The resistance force applying apparatus according to the above-described embodiment, which is configured to apply the resistance force against the stroke of the rotatably supported brake pedal, includes the rotational member coupled to the rotational shaft of the brake pedal, and the sliding member configured to apply the sliding resistance against the rotation of the rotational member by slidably contacting the rotational member. At least one of the sliding member, and the sliding portion of the rotational member, which the sliding member slidably contacts, has the inclination to cause the sliding resistance to change at the varying ratio according to the rotational position of the rotational member.

According to the thus-configured configuration, it is possible to improve the feeling that the operator has when operating the brake pedal. Further, it is possible to allow the operator to operate the brake pedal with the stable operational characteristic.

In the resistance force applying apparatus according to the above-described embodiment, the inclination of the sliding member or the rotational member is formed in such a manner that the sliding resistance increases until the rotational member reaches the predetermined rotational position, and increases at the higher ratio after the rotational member reaches the predetermined rotational position, as the rotational member rotates in response to pressing of the brake pedal.

According to the thus-configured configuration, it is possible to improve the feeling that the operator has when operating the brake pedal. Further, it is possible to allow the operator to operate the brake pedal with the stable operational characteristic.

In the resistance force applying apparatus according to the above-described embodiment, the inclination causes the sliding member to be axially displaced as the rotational member rotates. The spring member is provided, and the spring member is configured to press the sliding member against the sliding portion of the rotational member, and has the spring constant varying according to the position of the sliding member.

According to the thus-configured configuration, it is possible to improve the feeling than the operator has when operating the brake pedal. Further, it is possible to allow the operator to operate the brake pedal with the stable operational characteristic.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included, within the scope of this invention.

The present application claims priority to Japanese Patent Applications No. 2014-145881 filed on Jul. 16, 2014, The entire disclosures of No. 2014-145881 filed on Jul. 16, 2014 including specification, claims, drawings and summary are incorporated herein by reference in its entirety.

What is claimed is:

1. A booster comprising:
a housing;
an input, member disposed movably in a housing, and coupled to a brake pedal;
an electric motor configured to be actuated in response to an operation performed on the brake pedal;
an assist mechanism configured to thrust a piston in a master cylinder by the actuation of the electric motor; and
a resistance force applying mechanism, configured to apply a resistance force against a displacement of the input member relative to the housing,
wherein the resistance force applying mechanism includes a sliding portion having an inclination formed at the input member, and a sliding member configured to apply a sliding resistance against the displacement of the input member by slidably contacting the sliding portion, the resistance force applying mechanism being configured in such a manner that the sliding resistance changes at a varying ratio according to a position of the input member relative to the housing.

2. The booster according to claim 1, wherein the resistance force applying mechanism is configured in such a manner that the sliding resistance increases until the input member reaches a predetermined position, and increases at a higher ratio after the input member reaches the predetermined position, as the input member is displaced in response to pressing of the brake pedal.

3. The booster according to claim 1, wherein the resistance force applying mechanism is configured in such a manner that the sliding resistance increases until the input member reaches a predetermined position, and increases at a lower ratio after the input member reaches the predetermined position, as the input member is displaced in response to pressing of the brake pedal.

4. The booster according to claim 1, wherein the resistance force applying mechanism is configured in such a manner that the sliding resistance is maintained constant until the input member reaches a predetermined position, and increases after the input member reaches the predetermined position, as the input member is displaced in response to pressing of the brake pedal.

5. The booster according to claim 1, wherein the resistance force applying mechanism, includes a spring member configured to urge the sliding member toward the sliding portion of the input member, the spring member having a spring coefficient varying according to a position of the sliding member being displaced forward and rearward relative to the sliding portion along the inclination.

6. A stroke simulator configured to apply a reaction force against a displacement of an input member coupled to a brake pedal, the stroke simulator comprising:
a sliding member configured to apply a sliding resistance against the displacement of the input member; and
a sliding portion provided at a member in which the input member is inserted, and configured to slidably contact the sliding member,
wherein at least one of the input member and the sliding portion is provided with an inclination extending along a direction in which the input member is displaced, thereby causing the sliding resistance to change at a varying ratio according to a position of the input member.

7. The stroke simulator according to claim 6, wherein the inclination is shaped in such a manner that the sliding resistance increases until the input member reaches a predetermined position, and increases at a higher ratio after the input member reaches the predetermined position, as the input member is displaced in response to pressing of the brake pedal.

8. The stroke simulator according to claim 6, further comprising a spring member configured to apply a spring force against the displacement of the input member, the spring member having a spring constant varying according to a position of the sliding member.

9. A resistance force applying apparatus configured to apply a resistance force against a stroke of a rotatably supported brake pedal, the resistance force applying apparatus comprising:
a rotational member coupled to a rotational shaft of the brake pedal; and
a sliding member configured to apply a sliding resistance against a rotation of the rotational member by slidably contacting the rotational member,
wherein at least one of the sliding member, and a sliding portion of the rotational member, which the sliding member slidably contacts, has an inclination to cause the sliding resistance to change at a varying ratio according to a rotational position of the rotational member.

10. The resistance force applying apparatus according to claim 9, wherein the inclination is formed in such a manner that the sliding resistance increases until the rotational member reaches a predetermined rotational position, and increases at a higher ratio after the rotational member reaches the predetermined rotational position, as the rotational member rotates in response to pressing of the brake pedal.

11. The resistance force applying apparatus according to claim 9, wherein the inclination causes the sliding member to be axially displaced as the rotational member rotates, and
wherein a spring member is provided, the spring member being configured to press the sliding member against the sliding portion of the rotational member, the spring member having a spring constant varying according to a position of the sliding member.
